(19) United States
(12) Patent Application Publication
(10) Pub. No.: US 2026/0189518 A1
(43) Pub. Date: Jul. 2, 2026

(54) Method and device for initializing communication between a chatbot and a connected object

(71) Applicant: ORANGE, ISSY LES MOULINEAUX (FR)

(72) Inventors: Emmanuel Le Huerou, Chatillon (FR); François Toutain, Chatillon (FR)

(21) Appl. No.: 18/869,544

(22) PCT Filed: May 31, 2023
(86) PCT No.: PCT/EP2023/064521

§ 371 Date: Nov. 26, 2024

(30) Foreign Application Priority Data
Jun. 2, 2022 (FR) FR2205325

(51) Int. Cl. H04L 51/02; G06F 40/35

(52) U.S. Cl. CPC H04L 51/02; G06F 40/35

(57) ABSTRACT

A method and a device for initializing communication between a chatbot and a connected object. The method is implemented by an initialization device and includes: obtaining at least one first context datum comprising at least one identifier of a second connected object; evaluating the at least one first context datum based on at least one management rule associated with the chatbot; and when at least one rule of the chatbot is complied with, putting the chatbot in communication with the second connected object.

### 1. FIELD OF THE INVENTION

The invention relates to the field of telecommunications, and more specifically to the digital services delivered to a user by a chatbot.

### 2. PRIOR ART

A known operator service is the RCS (“Rich Communication Suite”) operator service and its RBM (Rich Business Messaging) component that defines the possible interactions between a user and a chatbot. By virtue of this service, a chatbot is able, for example, to analyze a message originating from a user, in natural language and/or via predefined choices/selections, in order to provide a suitable response thereto (proposals, actions, etc.).

The interaction between the user and the chatbot is established under the initiative of the user. There is no provision for a chatbot to be able to contact a user of its own accord (i.e. without previously receiving a message from the user) in order to avoid misuse such as unsolicited messages (spam). It should be noted that the RCS standard nevertheless allows a chatbot, after receiving a first message from the user, to send at most one unsolicited message per 24-hour slot.

However, usage cases exist whereby it would be desirable for a chatbot to be able to establish an interaction without prior solicitation. This is the case, for example, for interactions intended for connected terminals (bracelet, car, sensors, etc.) of a user, when said user is in a particular context, conducive to interaction with a service. There is therefore a need for a technical solution which makes it possible to establish an interaction between a chatbot and a third party when no previous relationship between these two parties exists and only a particular contextual situation occurs. Such a solution must also address the problems of misuse (spam), but must also maintain the anonymity of the user (and/or of the connected object belonging to them) with respect to the service provider (chatbot).

### 3. DISCLOSURE OF THE INVENTION

The invention improves the prior art and to this end proposes a method for initializing an interaction between a chatbot and a connected object, said method being implemented by an initialization device and characterized in that it comprises:
a step of obtaining at least one first context datum comprising at least one identifier of a second connected object;
a step of evaluating said at least one first context datum as a function of at least one management rule associated with a chatbot;
   and, when at least one rule of said chatbot is followed:
a step of connecting said chatbot with said second connected object.

Advantageously, this embodiment allows a chatbot to be connected with a connected object (second connected object within the meaning of the invention).

Specifically, the method previously holds and/or obtains management rules associated with the chatbot. These management rules are used to determine, for example, whether a connection (interaction) has to be made between the chatbot and a connected object. The method then obtains an identifier associated with a second connected object and context data. The context data corresponds, for example, to context data of a first connected object.

It should be noted that the identifier of the second connected object can be contained in the context data. These data are then evaluated in order to determine whether one of the management conditions/rules associated with the chatbot is followed. If so, the method ensures that an interaction is established between the chatbot and the second connected object.

The term “identifier” is intended to mean a sequence of characters used to identify an object and/or a user during an interaction. The identifier can be a messaging address, a Media Access Control (MAC) address, an IP address, a telephone number, a session number, etc.

“Context data” is understood to mean all the data collected and/or generated by a connected object. For example, the context data can be generated from the data collected by the connected object.

“Management rule” is understood to mean all the business rules allowing correct operation of a connected object and/or a connection to be triggered (establishing an interaction) between the connected object and a chatbot. For example, conditions (location, speed, temperature, altitude, etc.) and/or thresholds to be followed.

“Chatbot” is understood to mean a dialogue computing automaton able to dialogue with a user and/or a connected object. The chatbot generates messages intended for the user/connected object and interprets the responses that are fed back in order to respond to the requests/needs of the client.

According to a particular embodiment of the invention, a method as described above is characterized in that the connecting step comprises at least one step of sending said chatbot a request to initialize an interaction between said chatbot and said second connected object, said request comprising said at least one identifier of said second connected object.

Advantageously, this embodiment allows the method to send a connection request (request to initialize an interaction) to the chatbot. This request contains at least the identifier of the second connected object, thus allowing the chatbot to send a request to initialize an interaction to the second connected object. This embodiment allows the interaction to be initialized by the chatbot.

According to a particular embodiment of the invention, a method as described above is characterized in that the connecting step comprises at least:
a first step of establishing a first interaction with said chatbot;
a second step of establishing a second interaction with said second connected object;
a step of joining said first and said second interaction.

Advantageously, this embodiment allows the method to connect the chatbot and the second connected object via an operation for joining two interactions previously established by the method with the chatbot and the second connected object, respectively. By virtue of this embodiment, no information belonging to the second connected object is given to the chatbot, thus guaranteeing the anonymity of the user (and/or of the connected object belonging to them) with respect to the service provider (chatbot).

According to a particular embodiment of the invention, a method as described above is characterized in that said connecting step is followed or preceded by a step of sending a notification to said second connected object.

Advantageously, this embodiment allows, for example, the second connected object to be notified of the reception of a future request to initialize an interaction originating from a chatbot. Thus, a connected object that, for security reasons, would not accept a connection request from an unauthenticated/unknown third party can, for a predefined time period, for example ten seconds, listen to and accept the request to initialize an interaction originating from the chatbot.

Furthermore, the notification sent to the second connected object can comprise an identifier of the chatbot. Thus, when the second connected object receives a request to establish (initialize) an interaction, i.e. a request sent by the chatbot, the second connected object can retrieve the identifier of the chatbot present in the notification in order to ensure that the connection request has indeed been sent by the correct chatbot. Specifically, the identifier of the chatbot obtained from the notification and the identifier of the chatbot obtained from the initialization request are compared in order to determine whether they are identical. This embodiment allows additional security to be added when connecting.

Alternatively or cumulatively, the notification can comprise a secret (series of characters known only to the chatbot and the connected object) so that the connected object can authenticate the chatbot via a step of testing the secret (the method checks that the secret obtained in the initialization request is indeed valid/known).

Alternatively or cumulatively, the notification can comprise a datum encrypted via a symmetric encryption key, the key being shared between the chatbot and the connected object. Similarly, the connected object checks the identity of the chatbot via a step of testing the decrypted datum.

According to a particular embodiment of the invention, a method as described above is characterized in that said at least one first context datum comprises at least one configuration datum for said chatbot and in that the connecting step comprises a step of transmitting said at least one received configuration datum to said chatbot.

This embodiment allows the chatbot to be configured with configuration data belonging, for example, to the second connected object and/or to its user. For example, a configuration datum can be a customer identifier such as a loyalty card identifier. Thus, the chatbot can obtain information associated with the second connected object and/or with its user, allowing it to adapt/contextualize the first messages sent to the second connected object.

According to a particular embodiment of the invention, a method as described above is characterized in that said at least one first context datum comprises at least one context datum of a first connected object and in that said at least one context datum of said first connected object is obtained from said first connected object.

This embodiment allows the connection of the chatbot with the second connected object to be triggered as a function of context data of a first connected object (data generated/processed/associated with the first connected object), for example, when the first connected object determines that the second connected object is close to the first connected object.

According to a particular embodiment of the invention, a method as described above is characterized in that said at least one first context datum comprises at least one context datum of a first connected object and in that said at least one context datum of said first connected object is obtained from the network.

This embodiment allows the connection of the chatbot with the second [0031] connected object to be triggered as a function of context data of a first connected object, for example, when the first connected object determines that the second connected object is close to the first connected object. Furthermore, this embodiment allows the context data to be centralized within a server located in the network in order to establish statistics, for example. This embodiment also allows processing to be carried out on the context data originating from the connected object, by means of a processing server located in the network, for example, with a view to improving their relevance for triggering an interaction (for example improving the accuracy of satellite geolocation information).

According to a particular embodiment of the invention, a method as described above is characterized in that said first connected object corresponds to said second connected object.

Advantageously, this embodiment allows the connection between the chatbot and a connected object to be triggered as a function of the context data of the connected object to be contacted. When one of the management conditions/rules associated with the chatbot is followed, the method can then trigger the connection of the chatbot with the connected object.

According to a particular embodiment of the invention, a method as described above is characterized in that said at least one first context datum comprises at least one identifier of a chatbot and in that the evaluation of said at least one first context datum is carried out as a function of at least one management rule associated with said at least one identifier of said chatbot.

Advantageously, this embodiment allows the management rules to be specified that are to be checked for context data. This is the case, for example, when the context data are received from a connected object that executes or that is associated with a chatbot. The context data then includes the identifier of the chatbot, thus allowing the method to evaluate only the management rules of the chatbot associated with the connected object.

According to a particular embodiment of the invention, a method as described above is characterized in that the obtaining step further comprises obtaining at least one second context datum of a second connected object and in that the evaluation step corresponds to the evaluation of said first context datum and/or of said second context datum as a function of at least one management rule associated with said chatbot.

Advantageously, this embodiment allows the management rules of the chatbot to be evaluated as a function of the context data of a first and/or of a second connected object. The second context data includes context data of the second connected object and can be obtained from the second connected object and/or from the network.

The invention also relates to a device for initializing an interaction between a chatbot and a connected object, characterized in that the device comprises:
a module for obtaining at least one first context datum comprising at least one identifier of a second connected object;
a module for evaluating said at least one first context datum as a function of at least one management rule associated with a chatbot;
   and, when at least one rule of said chatbot is followed:
a module for connecting said chatbot with said second connected object.

The term module can equally correspond to a software component and to a hardware component or a set of hardware and software components, a software component itself corresponding to one or more computer programs or sub-programs or more generally to any element of a program able to implement a function or a set of functions as described for the relevant modules. Similarly, a hardware component corresponds to any element of a hardware assembly able to implement a function or a set of functions for the relevant module (integrated circuit, smart card, memory card, etc.).

The invention also relates to a computer program comprising instructions for implementing the above method according to any one of the particular embodiments described above, when said program is executed by a processor. The method can be implemented in various ways, in particular in wired form or in software form. This program can use any programming language, and be in the form of source code, object code, or of intermediate code between source code and object code, such as in a partially compiled format, or in any other desirable format.

The invention also relates to a storage medium or to a computer-readable information medium, and comprising instructions of a computer program as mentioned above. The aforementioned storage media can be any entity or device capable of storing the program. For example, the medium can comprise a storage means, such as a ROM, for example a CD-ROM or a microelectronic circuit ROM, or even a magnetic recording means, for example a hard disk. Moreover, the storage media can correspond to a transmissible medium such as an electrical or optical signal, which can be routed via an electrical or optical cable, via a radio or via other means. The programs according to the invention may in particular be downloaded over a network of the Internet type.

Alternatively, the storage media can correspond to an integrated circuit, in which the program is incorporated, the circuit being adapted to execute or to be used to execute the considered method.

This initialization device and this computer program have features and advantages similar to those previously described with reference to the initialization method.

### 4. LIST OF THE FIGURES

Further features and advantages of the invention will become more clearly apparent upon reading the following description of particular embodiments, which are provided by way of simple illustrative and non-limiting examples, and with reference to the appended drawings, in which:

FIG. 1 illustrates an example of an environment for implementing the invention according to a particular embodiment of the invention;

FIG. 2 schematically illustrates an example of the architecture of a device suitable for implementing the initialization method according to a particular embodiment of the invention;

FIG. 3 illustrates the main steps of the initialization method according to a particular embodiment of the invention.

### 5. DESCRIPTION OF AN EMBODIMENT OF THE INVENTION

FIG. 1 illustrates an example of an environment for implementing the invention according to a particular embodiment of the invention. FIG. 1 more specifically illustrates a terminal 103 able to implement the initialization method according to a particular embodiment.

It should be noted in this case that, although the terminal 103 illustrated in FIG. 1 in this case corresponds to a “server”-type terminal, the invention can be applied to any type of terminal with the architecture of a computer such as, for example, and in a non-limiting manner, a games console, a television, a cash dispenser, connected terminals/objects, a router, a tablet, a personal computer, a smartphone, etc.

In the example described with reference to FIG. 1, the terminal 103 is a server located in a private or public network (for example the Internet) operated by a service provider, the services being provided through one or more chatbots, for example. The terminal 103 can communicate with a plurality of connected objects such as, for example, the connected object 102 (second connected object within the meaning of the invention), which in this example corresponds to an on-board computer of a connected electric car and the connected object 101 (first connected object within the meaning of the invention), which in this example corresponds to an electrical charging terminal. The terminal 103 also communicates with a chatbot, which in this example is hosted in an electrical charging terminal 101.

According to a particular embodiment of the invention, the second connected object within the meaning of the invention can correspond to a smartphone or to the electronic tablet of the user connected to the computer/dashboard of the electric car 102.

According to a particular embodiment of the invention, the chatbot can be partially or completely distributed between the electrical charging terminal and a platform (i.e. a server) located in the network (not shown).

The interactions between the various elements are made, for example, via the network 100 (for example an IP network and/or a circuit) and the RCS (Rich Communication Services) technology.

According to a particular embodiment of the invention, the electric vehicle 102 can dialogue directly with the chatbot of the charging terminal 101. The interaction can be wired, via for example PLC (Power Line Carrier) technology when the electric car 102 is connected to the terminal 101 or even wireless via, for example, Bluetooth®, Wi-Fi® and/or cellular radiotelephony technologies.

According to a particular embodiment of the invention, the terminal 103 can implement the initialization method. In this case, the terminals 103 and 101 are the one and the same terminal.

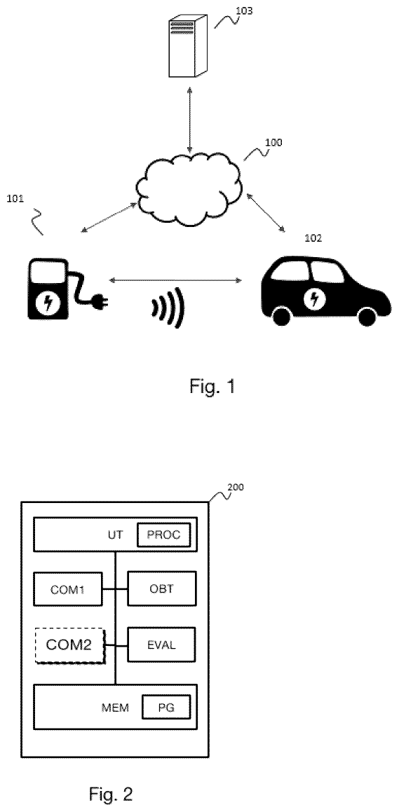

FIG. 2 illustrates a device 200 configured to implement the initialization method according to a particular embodiment. r

According to a particular embodiment of the invention, the device 200 has the conventional architecture of a computer, and in particular comprises a memory MEM, a processing unit UT, equipped, for example, with a processor PROC, and controlled by the computer program PG stored in the memory MEM. The computer program PG comprises instructions for implementing the steps of the initialization method as described above, when the program is executed by the processor PROC.

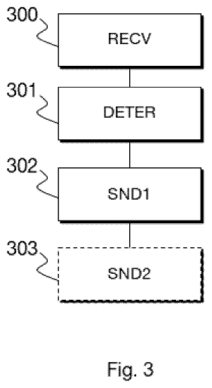

Upon initialization, the code instructions of the computer program PG are loaded, for example, into a memory before being executed by the processor PROC. The processor PROC of the processing unit UT in particular implements the steps of the initialization method according to any one of the particular embodiments described with reference to FIGS. 1 and 3, according to the instructions of the computer program PG.

The device 200 comprises a module OBT that is able to obtain context data that comprises at least one identifier of a connected object (second connected object within the meaning of the invention, i.e. an identifier of an on-board computer of the connected electric car (102)).

According to a particular embodiment, the context data obtained by the module OBT are context data of the charging terminal 101.

The device 200 also comprises a digital storage module (for example the memory MEM) able to store the management rules associated with a chatbot (for example the management rules associated with the chatbot hosted/executed by the charging terminal 101).

In addition, the device 200 comprises a module EVAL that is able to evaluate whether one of the context datums follows one of the management conditions/rules of a chatbot (threshold reached or exceeded, time slot, status of the connected object (free/occupied), etc.).

The device 200 further comprises a module COM1 that is configured to connect a chatbot and a connected object via a network, for example an IP network and/or a circuit. This module can be used, for example, to interact with the chatbot of the charging terminal 101 so that the chatbot sends a request to initialize an interaction that is intended for a connected object. This module also can be used to establish an interaction with a chatbot.

According to a particular embodiment, the device 200 can also comprise a module COM2 that is able to establish an interaction with a connected object (for example the dashboard of the car 102) via a network (100), for example an IP network and/or a circuit. When the device establishes an interaction with a connected object (via the module COM2) and an interaction with a chatbot (via the module COM1), the device can join the two interactions via a joining module (not shown) so that the chatbot and the connected object can interact without an intermediary.

According to a particular embodiment, the module COM1 and the module COM2 are one and the same module.

According to a particular embodiment, the module OBT1 is included in the module COM2 or in the module COM1.

FIG. 3 illustrates steps of the initialization method according to one of the particular embodiments of the invention described above, with the method being executed on the terminal 103 described in [FIG. 1].

In this particular embodiment, the first connected object within the meaning of the invention corresponds to the second connected object within the meaning of the invention, for example to the dashboard of the electric car 102.

During a first step 300, the method obtains context data relating to the electric car 102. These data relate, for example, to its position (for example GPS data), the charge level of the batteries, the estimated range, an identifier of the car 102 and more generally all the data associated with the electric car. These data are obtained from the car 102 and/or from a server located in the network (not shown) that is able to collect the data managed and/or generated by the car by telemetry via its onboard computer and/or its onboard sensors, for example.

According to a particular embodiment, in the case whereby the second connected object within the meaning of the invention corresponds to an electronic tablet or to a smartphone connected to the dashboard of the electric car 102, the context data of the electric car 102 can include an identifier allowing the smartphone/the electronic tablet to be joined (for example a telephone number and/or an electronic address such as an instant messaging address) and/or data obtained, managed and/or generated by the electronic tablet/smartphone (parameters of the car such as the charge level of the electric batteries, the GPS position, etc.).

According to a particular embodiment, the method can also obtain context data of the charging terminal 101 such as the charging time slots reserved by other vehicles or even its state/status (free/occupied/functional/non-functional). It should be noted that the context data of the charging terminal 101 can comprise or correspond to at least one identifier of the chatbot hosted/executed on the charging terminal 101. The context data of the charging terminal 101 can be obtained from the charging terminal itself or even from a server located in the network (not shown) that is able to collect the data managed and/or generated by the charging terminal 101 and/or its on-board sensors by telemetry. The context data of the charging terminal 101 also can be obtained from the car/on-board computer 102 in the case whereby the vehicle is located in the vicinity of the charging terminal 101. The context data of the charging terminal 101 are obtained, for example, by the vehicle 102 from the charging terminal 101 via Wi-Fi®, Bluetooth®, NFC® (Near Field Communication), ZigBee®, QR code (Quick Response code), IrDA (Infra-red Data Association) technology, etc. Before the step 300 or during the step 300, the method obtains management rules of the chatbot hosted/executed on the charging terminal 101. These rules are obtained from the terminal 101 and/or from a server located in the network (for example a memory space of the terminal 103) that is able to store the management rules associated with the chatbot of the terminal 101. The management rules are associated, for example, with an identifier of the chatbot of the terminal 101.

During the step 301, the method determines whether one of the rules associated with the chatbot of the terminal 101 is followed. Specifically, the rules of the chatbot can be:
reaching a threshold for a particular context datum, for example the charge level of the batteries of the vehicle 102 (50%, 60%, 70%, etc.);
the position (GPS coordinates obtained in the context data) of the car 102 within a predefined area, for example within a radius of 2 km of the terminal 101;
a reservation for charging on a third-party charging terminal within a short deadline, for example 30 minutes after the current time;
the presence of the identifier of the vehicle 102 in a whitelist. For example, a list of vehicles in a corporate fleet;
the presence of the identifier of the vehicle 102 in a blacklist. Indeed, a dispute may have occurred between the manager of the charging service and the user of the vehicle 102. In this case, the manager can prohibit its charging infrastructures to the user and consequently to the vehicle 102;
the status/state of the charging terminal (free/occupied/functional/non-functional) 101;
the reserved/available charging time slots;
etc.

Obviously, the management rules can be combined. For example, a management rule associated with the chatbot of the charging terminal 101 can be: initializing an interaction with the dashboard of a connected car (second connected object within the meaning of the invention) when the car is located close to the charging terminal 101 (for example less than 1 km away) and the charge level of the batteries of the vehicle is less than 50%.

In this case, during the step 301, the method evaluates, by virtue of the GPS coordinates of the car 102 included in the context data obtained during the step 300, the distance between the car 102 and the charging terminal 101. Thus, the method can determine whether the car 102 is located in the vicinity of the charging terminal 101. Cumulatively, the method can check the charge level of the batteries of the car 102 in the context data obtained during the step 300.

According to a particular embodiment, the method can alternatively or cumulatively evaluate the rules for managing a second connected object such as the charging terminal 101. For example, the state/the availability of the charging terminal 101 (free/occupied). For example, the method can add the (free/unused) availability condition of the charging terminal 101 to the proximity and charge-level conditions of the batteries of the vehicle 102.

It should be noted that when an identifier of the chatbot of the charging terminal 101 is present in the context data obtained from the charging terminal 101, the method can only evaluate the management rules associated with the identifier of the chatbot of the charging terminal 101.

During the step 302, when a management rule of the chatbot of the charging terminal 101 is followed, the method connects the chatbot of the charging terminal 101 and the dashboard of the vehicle 102. The chatbot can thus offer the driver of the vehicle 102 via, for example, the screen of the dashboard and/or the audio system of the vehicle (voice message), to reserve the current time slot in order to charge the batteries.

According to a particular embodiment, when a management rule of the chatbot of the charging terminal 101 is followed, the method connects the chatbot of the charging terminal 101 and a terminal connected to the on-board computer/dashboard of the vehicle 102 (for example the smartphone or the electronic tablet of the user). The chatbot can thus offer the driver of the vehicle 102 via, for example, the screen of the smartphone/of the tablet and/or the audio system of the smartphone/of the tablet (voice message), to reserve the current time slot for charging the batteries.

According to a particular embodiment, the method can send the chatbot of the charging terminal 101 a request to initialize (303) an interaction between the chatbot of the charging terminal 101 and the dashboard of the car 102. This request can include the identifier of the vehicle 102 and/or of the dashboard of the vehicle 102 obtained during the step 300 allowing the chatbot to establish the interaction with the dashboard of the vehicle 102. According to a particular embodiment, this request can include the identifier of a terminal connected to the dashboard of the vehicle 102.

According to a particular embodiment, the method can establish a first interaction with the dashboard of the vehicle 102 and a second interaction with the chatbot of the charging terminal 101, then join the two interactions so that the chatbot of the charging terminal 101 and the dashboard of the vehicle 102 can interact without an intermediary. It should be noted that the interaction with the dashboard of the vehicle 102 can be established by virtue of the identifier of the vehicle 102 and/or of the identifier of the dashboard of the vehicle 102 obtained during the step 300. According to a particular embodiment, the first interaction is established with a terminal connected to the dashboard of the vehicle 102. It should be noted that in this case the interaction with the terminal can be established by virtue of the identifier of the terminal obtained during the step 300.

Of course, the embodiment that has been described above has been provided solely by way of indication and is by no means limiting, and numerous modifications can be easily made by a person skilled in the art, without departing from the scope of the invention.

For example, the first connected object within the meaning of the invention can be different from the second connected object within the meaning of the invention; the first connected object can correspond to the charging terminal 101 and the second connected object can correspond to the vehicle 102 (for example the dashboard).

Thus, during the first step 300, the method obtains context data from the charging terminal 101. These data are, for example, the state/status of the terminal (free/occupied/functional/non-functional), the time slots reserved for the relevant terminal, an identifier of the chatbot of the charging terminal, etc. These data are obtained from the terminal 101 and/or from a server located in the network (not shown) that is able to collect the data managed and/or generated by the terminal by telemetry via on-board sensors, for example.

These context data can also comprise an identifier of the vehicle 102 (or of a terminal connected to the on-board computer of the vehicle 102) obtained by the terminal 101 when vehicle 102 is in the vicinity of the terminal 101. The identifier of the vehicle 102 is obtained, for example, via Wi-Fi®, Bluetooth®, NFC® (Near Field Communication), ZigBee®, QR code (Quick Response code), IrDA (Infra-red Data Association) technology, etc.

According to a particular embodiment, the method can also obtain context data from the vehicle 102. These data relate, for example, to the position of the vehicle 102 (for example a GPS datum), the charge level of the batteries, the estimated range, an identifier of the car 102 and more generally all the data associated with the electric car. These data are obtained from the car 102 and/or from a terminal connected to the car 102 (smartphone/electronic tablet) and/or from a server located in the network (not shown) that is able to collect the data obtained, managed and/or generated by the terminal connected to the on-board computer of the car 102 and/or by the car itself by telemetry via its on-board computer and/or its on-board sensors, for example. The context data of the vehicle 102 also can be obtained from the charging terminal 101. Indeed, when the vehicle 102 is located in the vicinity of a charging terminal (for example the terminal 101), the vehicle can transmit its context data to the terminal, which, once it has collected the data, transmits the context data of the vehicle 102 to the server 103.

Prior to the step 300, or even during the step 300, the method obtains rules for managing the chatbot of the charging terminal 101. These rules are obtained from the terminal 101 and/or from a server located in the network (for example a memory space of the terminal 103) that is able to store the management rules associated with the chatbot of the terminal 101. The management rules are associated, for example, with an identifier of the chatbot of the terminal 101.

During the step 301, the method determines whether one of the rules of the chatbot of the terminal 101 is followed. It should be noted that the management rules can be evaluated as a function of the context data of the charging terminal 101 and/or of the context data of the vehicle 102.

It also should be noted that when an identifier of the chatbot of the charging terminal 101 is present in the context data obtained from the charging terminal 101, the method can only evaluate the management rules associated with the identifier of the chatbot of the charging terminal 101.

During the step 302, the method connects the chatbot of the charging terminal 101 and the dashboard of the vehicle 102. The embodiments described above that allow an interaction to be established between the chatbot of the charging terminal 101 and the dashboard of the vehicle 102 remain valid.

According to a particular embodiment, during the step 302, the method connects the chatbot of the charging terminal 101 and the terminal of the user (smartphone/electronic tablet) connected to the on-board computer of the car 102.

According to a particular embodiment, the method can also send a notification (303) to the vehicle 102 indicating that a request to initialize an interaction will be sent by the chatbot of the terminal 101, the notification comprising an identifier of the chatbot of the terminal 101. This embodiment allows unsolicited messages to be avoided. Thus, only the interaction requests originating from chatbots for which an identifier has been received in advance will be accepted by the vehicle/dashboard 102.

According to a particular embodiment, the method can, during the step 300, obtain configuration data of the chatbot of the terminal 101 in the context data. These configuration data can include an identifier of the chatbot of the terminal 101 and/or all the data allowing the chatbot of the terminal 101 to adapt the messages sent to the vehicle 102 during and after an interaction is established. The data can be a charging log, an identifier of a loyalty card for adjusting the charging cost, the name of the user of the vehicle 102, etc.

Specifically, once the configuration data have been obtained (step 300), the method sends the configuration data to the chatbot during the connecting step 302. These configuration data can be included in the request to initialize an interaction between the chatbot of the terminal 101 and the vehicle/dashboard of the vehicle 102, the request being sent to the chatbot. Alternatively, these configuration data can be included in a request to establish an interaction sent by the method to the chatbot of the terminal 101.

1. A method for initializing an interaction between a chatbot and a connected object, said method being implemented by an initialization device and comprising:
obtaining at least one first context datum comprising at least one identifier of a second connected object;
evaluating said at least one first context datum as a function of at least one management rule associated with a chatbot;
and, in response to at least one rule of said chatbot being followed:
connecting said chatbot with said second connected object.

2. The method as claimed in claim 1, wherein the connecting comprises at least one step of sending said chatbot a request to initialize an interaction between said chatbot and said second connected object, said request comprising said at least one identifier of said second connected object.

3. The method as claimed in claim 1, wherein the connecting comprises at least:
a first step of establishing a first interaction with said chatbot;
a second step of establishing a second interaction with said second connected object; and
a step of joining said first and said second interaction.

4. The method as claimed in claim 1, wherein said connecting is followed or preceded by sending a notification to said second connected object.

5. The method as claimed in claim 1, wherein said at least one first context datum comprises at least one configuration datum for said chatbot and the step comprises transmitting said at least one received configuration datum to said chatbot.

6. The method as claimed in claim 1, wherein said at least one first context datum comprises at least one context datum of a first connected object and said at least one context datum of said first connected object is obtained from said first connected object.

7. The method as claimed in claim 1, wherein said at least one first context datum comprises at least one context datum of a first connected object and said at least one context datum of said first connected object is obtained from a network.

8. The method as claimed in claim 7, wherein said first connected object corresponds to said second connected object.

9. The method as claimed in claim 1, wherein said at least one first context datum comprises at least one identifier of a chatbot and the evaluation of said at least one first context datum is carried out as a function of at least one management rule associated with said at least one identifier of said chatbot.

10. The method as claimed in claim 1, wherein the obtaining further comprises obtaining at least one second context datum of a second connected object and the evaluating corresponds to evaluation of said first context datum and/or of said second context datum as a function of at least one management rule associated with said chatbot.

11. A device for initializing an interaction between a chatbot and a connected object, wherein the device comprises:
at least one processor; and
at least one non-transitory computer readable medium comprising instructions stored thereon which when executed by the at least one processor configure the device to:
obtain at least one first context datum comprising at least one identifier of a second connected object;
evaluate said at least one first context datum as a function of at least one management rule associated with a chatbot; and
connect said chatbot with said second connected object in response to at least one rule of said chatbot being followed.

12. A non-transitory computer readable medium comprising a computer program stored thereon comprising instructions for implementing a method for initializing an interaction between a chatbot and a connected object, when the program is executed by a processor, wherein the method comprises: and comprising:
obtaining at least one first context datum comprising at least one identifier of a second connected object;
evaluating said at least one first context datum as a function of at least one management rule associated with a chatbot;
and, in response to at least one rule of said chatbot being followed:
connecting said chatbot with said second connected object.
